(19) United States
(12) Patent Application Publication
(10) Pub. No.: US 2024/0411552 A1
(43) Pub. Date: Dec. 12, 2024

(54) RECOMMENDED METHODS, DEVICES, ELECTRONIC DEVICES, AND STORAGE MEDIA FOR LARGE MODEL INTERFACE CONFIGURATION

(71) Applicant: BEIJING BAIDU NETCOM SCIENCE TECHNOLOGY CO., LTD., Beijing (CN)

(72) Inventors: Jing XIA, Beijing (CN); Jun LIU, Beijing (CN); Binbin XU, Beijing (CN); Kuan SHI, Beijing (CN); Shupeng LI, Beijing (CN); Zhengyu QIAN, Beijing (CN); En SHI, Beijing (CN)

(21) Appl. No.: 18/748,345

(22) Filed: Jun. 20, 2024

(30) Foreign Application Priority Data
May 22, 2024 (CN) 202410643334.4

(51) Int. Cl. G06F 8/71; G06F 11/36

(52) U.S. Cl. CPC G06F 8/71; G06F 11/3668

(57) ABSTRACT

A computer-implemented method for recommending a large model interface configuration includes: obtaining a search space of a model interface configuration and a test data set, wherein the search space comprises at least one candidate model interface and a value range of a hyperparameter; and obtaining a plurality of model interface configuration sets based on the search space, wherein each model interface configuration set comprises a candidate model interface and a value of the hyperparameter; and obtaining a test result corresponding to each model interface configuration set, by using the test data set to test a large model called based on each model interface configuration set; and determining a target interface configuration based on the test results corresponding to the plurality of model interface configuration sets.

### CROSS-REFERENCE TO RELATED APPLICATION

The present application is based upon and claims priority to Chinese Patent Application No. 2024106433344, filed on May 22, 2024, the entire contents of which are incorporated herein by reference.

### TECHNICAL FIELD

The present disclosure relates to the field of computer technology, in particular to the field of artificial intelligence such as deep learning and large models, and in particular to a method and an apparatus for recommending a large model interface configuration, an electronic device, and a storage medium.

### BACKGROUND

A large model is a machine learning model with a large scale of parameters and a high complexity. The large model may generate a natural language text and also understand the meaning of the text deeply. The large model may process a variety of natural language tasks, such as a text summarization task, a question and answer (Q&A) task, a translation task, etc. With the increasing number and scale of the large model, how to select an appropriate model prediction service to meet specific needs has become an urgent problem to be solved.

### SUMMARY

According to a first aspect of the present disclosure, a method for recommending a large model interface configuration is provided, including: obtaining a search space of a model interface configuration and a test data set, in which the search space includes at least one candidate model interface and a value range of a hyperparameter; and obtaining a plurality of model interface configuration sets based on the search space, in which each model interface configuration set includes a candidate model interface and a value of the hyperparameter; and obtaining a test result corresponding to each model interface configuration set, by using the test data set to test a large model called based on each model interface configuration set; and determining a target interface configuration based on the test results corresponding to the plurality of model interface configuration sets.

According to a second aspect of the present disclosure, an electronic device is provided, including: at least one processor; and a memory communicatively coupled to the at least one processor and storing instructions executable by the at least one processor. When the instructions are executed by the at least one processor, the at least one processor is caused to perform the method according to the above first aspect.

According to a third aspect of the present disclosure, a non-transitory computer readable storage medium, storing computer instructions is provided, in which the computer instructions are caused to enable a computer to perform the method according to the above first aspect.

### BRIEF DESCRIPTION OF THE DRAWINGS

The drawings are used for a better understanding of the present embodiment and do not constitute a limitation of the present disclosure.

FIG. 1 is a flowchart illustrating a method for recommending a large model interface configuration according to an embodiment of the present disclosure.

FIG. 2 is a flowchart illustrating a method for recommending a large model interface configuration according to another embodiment of the present disclosure.

FIG. 3 is a schematic diagram illustrating second prompt information according to an embodiment of the present disclosure.

FIG. 4 is a schematic diagram illustrating first prompt information according to an embodiment of the present disclosure.

FIG. 5 is a schematic diagram illustrating third prompt information according to an embodiment of the present disclosure.

FIG. 6 is a flowchart illustrating a process for searching an interface configuration and determining a recommended target interface configuration by using a target large language model according to an embodiment of the present disclosure.

FIG. 7 is a flowchart illustrating a method for recommending a large model interface configuration according to another embodiment of the present disclosure.

FIG. 8 is a block diagram illustrating a system for recommending a large model interface configuration according to an embodiment of the present disclosure.

FIG. 9 is a schematic diagram illustrating an application scenario of a method for recommending a large model interface configuration according to an embodiment of the present disclosure.

FIG. 10 is a structure diagram illustrating an apparatus for recommending a large model interface configuration according to an embodiment of the present disclosure.

FIG. 11 is a block diagram illustrating an electronic device configured to implement a method for recommending a large model interface configuration according to an embodiment of the present disclosure.

### DETAILED DESCRIPTION

Exemplary embodiments of the present disclosure are described hereinafter in conjunction with the accompanying drawings, which include various details of the embodiments of the present disclosure in order to aid in understanding, and which should be considered exemplary only. Accordingly, one of ordinary skill in the art should recognize that various changes and modifications can be made to the embodiments described herein without departing from the scope of the present disclosure. Similarly, descriptions of well-known features and structures are omitted from the following description for the sake of clarity and brevity.

A method and an apparatus for recommending a large model interface configuration, an electronic device, and a storage medium are described below with reference to the accompanying drawings according to the embodiments of the present disclosure.

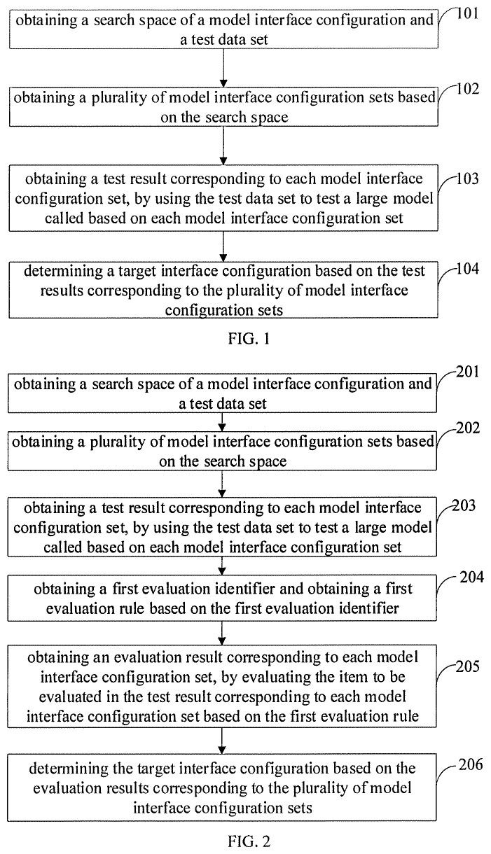

FIG. 1 is a flowchart illustrating a method for recommending a large model interface configuration according to an embodiment of the present disclosure.

Different large models have different features and application scenarios, and prediction costs of different large models are also different. With the increasing number and scale of the large model, how to select the appropriate model prediction service to meet specific needs has become an urgent problem to be solved. In addition, for the prediction service of the large model, there are also some hyperparameters that affect a prediction performance of the model, such as temperature, top_k, top_p, etc. Thus, enhancing the effect of the prediction service by efficiently optimizing inference hyperparameters is also a challenge for developers.

Accordingly, a method for recommending a large model interface configuration is provided according to an embodiment of the present disclosure, and the method may be performed by an apparatus for recommending a large model interface configuration according to an embodiment of the present disclosure, which may be configured in an electronic device to realize a function for recommending a large model interface configuration.

The electronic device may be any device with a computing power, for example, a personal computer, a mobile terminal, a server, etc., and the mobile terminal may be, for example, a vehicle-mounted device, a cellular phone, a tablet computer, a personal digital assistant, a wearable device, and other hardware devices having a variety of operating systems, touchscreens, and/or displays.

For example, a method for recommending a large model interface configuration according to an embodiment of the present disclosure may be applied to a system for recommending a large model interface configuration, which may include a client and a server, and the method for recommending a large model interface configuration may be executed by the server in the recommendation system.

As shown in FIG. 1, the method for recommending a large model interface configuration includes the following steps 101 to 104.

At step 101, a search space of a model interface configuration and a test data set are obtained.

In the present disclosure, the search space for the model interface configuration may include at least one candidate model interface and a value range of a hyperparameter etc. The candidate model interface may be a model interface of a large model. In addition, there may be one or more hyperparameters, which is not limited herein.

For example, the hyperparameters are such as temperature, top_k, top_p, etc., in which, temperature is a key hyperparameter configured to control the randomness and diversity of the text generated by the large model; top_k sampling is a strategy to restrict the large model to consider top k options with the highest probability when selecting the next word; top_p sampling is a restriction based on a cumulative probability, in which the large model only considers the words whose total probability reaches a proportion of p, which can be viewed as a probability truncated distribution strategy.

For example, the candidate model interfaces in the search space include “interface1” and “interface2”, and the value range of the hyperparameter temperature is (0,1).

In the present disclosure, the test data in the test data set matches the input of the large model corresponding to the candidate model interface. For example, in the case that the user wants to obtain a large model interface configuration recommended with an image-to-text function, then the test data in the test data set is image data. Alternatively, the test data set may include at least one piece of test data, or the test data set may include at least one test sample.

In the present disclosure, a client interface of the system for recommending a large model interface configuration has an input control for the model interface configuration. For example, the input control includes a candidate model interface selection control, a hyperparameter input control, etc. An input control for the test data set may also be included. As such, a user may select the candidate model interface and the value range of the hyperparameter, etc. on the client interface, to input the search space of the model interface configuration, and the user may also upload a test data set on the client interface, or input a path to the test data set on the client interface. In this way, the search space and the test data set for the model interface configuration may be obtained by the server of the system for recommending a large model interface configuration.

For example, the client, in response to detecting a submission control for a task of recommending the large model interface configuration being triggered, sends a request of recommending the model interface configuration to the server. The request of recommending the model interface configuration may include the search space and the path to the test data set. Then, the server may receive the request of recommending the model interface configuration from the client and obtain the search space and the path to the test data set from the request of recommending, and may obtain the test data set by accessing the path to the test data set.

For example, the path to the test data set may be an accessible local path or a remote access address.

At step 102, a plurality of model interface configuration sets are obtained based on the search space.

Each model interface configuration set includes a candidate model interface and a value of the hyperparameter.

For example, in the present disclosure, the plurality of model interface configuration sets may cover all the candidate model interfaces in the search space.

For example, a value may be selected from a value range of the hyperparameter for each candidate model interface in the search space, and a model interface configuration set may be obtained based on each candidate model interface and the selected value of the hyperparameter.

For example, a plurality of values are selected from the value range of the hyperparameter for the same candidate model interface in the search space, and a model interface configuration set may be obtained based on the candidate model interface and each value of the plurality of values of the hyperparameter. Thus, in the different interface configurations, the candidate model interface may be the same but the value of the hyperparameter is different.

For example, a number of model interface configurations may be greater than or equal to a number of candidate model interfaces in the search space.

At step 103, a test result corresponding to each model interface configuration set is obtained, by using the test data set to test a large model called based on each model interface configuration set.

In the present disclosure, the test result corresponding to each model interface configuration set may be obtained, by using the test data set to test the large model called based on each model interface configuration set.

The test result corresponding to each model interface configuration set may include, but are not limited to, an output result of the large model, an average time latency of an interface call, a call cost, etc.

The output result of the large model may include output results obtained by inputting each test data in the test data set into the large model respectively. The average time latency of the interface call may be an average time taken from calling an interface to returning a result when the test data set is used for testing. The call cost may be a cost of a single calling to the large model, or a call cost when the test data set is used for testing.

At step 104, a target interface configuration is determined based on the test results corresponding to the plurality of model interface configuration sets.

In the present disclosure, the model interface configuration may be continued to be searched in the search space based on the test results corresponding to the plurality of model interface configuration sets, and then the target interface configuration may be determined from all the model interface configurations searched.

Alternatively, the target interface configuration may be determined from the plurality of model interface configuration sets based on the test results corresponding to the plurality of model interface configuration sets.

For example, a model interface configuration whose test result meets a user demand may be selected from the plurality of model interface configuration sets as the target interface configuration.

For example, in case that the user demand takes the average call time latency as a major consideration, then the model interface configuration with the smallest average call time latency may be determined among the test results corresponding to the plurality of model interface configuration sets, and the model interface configuration may be taken as the target interface configuration.

In the embodiment of the present disclosure, the plurality of model interface configuration sets are obtained based on the search space, the test result corresponding to each model interface configuration set is obtained by using the test data set to test the large model called based on each model interface configuration set, and the target interface configuration is determined based on the test results corresponding to the plurality of model interface configuration sets. Thus, the accuracy and recommendation efficiency of recommending the large model interface configuration may be improved by using the test data set to search for the recommended interface configuration from the search space.

FIG. 2 is a flowchart illustrating a method for recommending a large model interface configuration according to another embodiment of the present disclosure.

As shown in FIG. 2, the method for recommending a large model interface configuration includes the following steps 201 to 206.

At step 201, a search space of a model interface configuration and a test data set are obtained.

In the present disclosure, the step 201 may be performed by any one implementation of the embodiments of the present disclosure, which will not be discussed herein.

At step 202, a plurality of model interface configuration sets are obtained based on the search space.

In the present disclosure, the step 202 may be performed by any one implementation of the embodiments of the present disclosure, which will not be discussed herein.

For example, the plurality of model interface configuration sets may be obtained by using the target large language model, based on the search space.

As an example, a second output requirement for the model interface configuration may be obtained, and second prompt information is generated based on the search space and the second output requirement. Then, the plurality of model interface configuration sets are obtained by inputting the second prompt information into the target large language model for processing. Thus, a desired model interface configuration may be searched more efficiently by searching for the model interface configuration from the search space based on the target large language model.

The second output requirement for the model interface configuration includes at least one of: a second condition that the model interface configuration satisfies, a requirement for a number of model interface configurations, and a format requirement for the model interface configuration, etc. For example, the second condition may be “all the candidate model interfaces in the search space are covered by a given model interface configuration”.

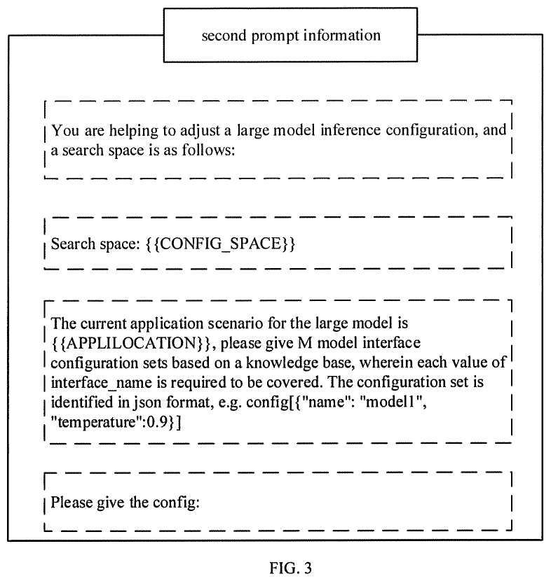

For example, the second prompt information may be as shown in FIG. 3, in which a number of interface configurations output by the model is required to be M, and a value of M may be equal to a number of candidate model interfaces in the search space, and a format for the model interface configuration output by the model is required to be a json format.

In the present disclosure, the target large language model used for searching the model interface configuration may be the same as or different from a large language model used for evaluating an item to be evaluated based on a first evaluation rule, which is no limited herein.

At step 203, a test result corresponding to each model interface configuration set is obtained, by using the test data set to test a large model called based on each model interface configuration set.

In the present disclosure, the step 203 may be performed by any one implementation of the embodiments of the present disclosure, which will not be discussed herein.

At step 204, a first evaluation identifier is obtained and a first evaluation rule is obtained based on the first evaluation identifier.

In the present disclosure, the client interface may also have an input control for the evaluation rule, and the user may input an evaluation rule to be used while inputting the search space in the client interface. The evaluation rule is configured to evaluate the test result of the model interface configuration. For example, the client interface may display registered evaluation rules from which the user may select the evaluation rule to be used.

For example, the client, in response to detecting a submission control for a task of recommending the large model interface configuration being triggered, sends a request of recommending the model interface configuration to the server. The request of recommending the model interface configuration may further includes the first evaluation identifier, so that the server may obtain the inputted first evaluation identifier and obtain the first evaluation rule, based on the first evaluation identifier. The first evaluation identifier may be used to identify first evaluation information, and the first evaluation information may include the first evaluation identifier, the first evaluation rule, etc.

For example, the first evaluation rule is “please compare a similarity between a predicted output and a label, and output according to the similarity, a score of an integer between 0 and 10 \n predicted output: {{output}}\n label: {{label}}\n score:”

At step 205, an evaluation result corresponding to each model interface configuration set is obtained, by evaluating the item to be evaluated in the test result corresponding to each model interface configuration set based on the first evaluation rule.

In the present disclosure, the first evaluation rule may be identified to determine the item to be evaluated in the first evaluation rule, and the evaluation result corresponding to each model interface configuration set may be obtained by evaluating the item to be evaluated in the test result corresponding to each model interface configuration set by using the first evaluation rule.

For example, the item to be evaluated may be one or more of an output result of the model, an average time latency of the interface call, a call cost, etc.

For example, the items to be evaluated in the first evaluation rule include the output result of the model and the average time latency of the interface call, which indicates the user wishes to comprehensively consider the model prediction performance and the time latency when the model interface configuration is recommended. Then the evaluation result may be obtained by evaluating the output result corresponding to each model interface configuration set and the average time latency of the interface call according to the first evaluation rule.

For example, the item to be evaluated in the test result corresponding to the model interface configuration may be evaluated based on the first evaluation rule by using the large language model, and the evaluation result corresponding to the model interface configuration is obtained. Thus, the accuracy of the evaluation result may be improved by using the large language model to perform the evaluation.

For example, prompt information may be generated based on the first evaluation rule and the test result, and the evaluation result may be obtained by inputting the prompt information into the large language model for processing.

It is noted that the items to be evaluated may be the same or different for different evaluation rules, which is not limited herein.

At step 206, the target interface configuration is determined based on the evaluation results corresponding to the plurality of model interface configuration sets.

As a possible implementation, a new interface configuration in the search space may be searched based on the evaluation results corresponding to the plurality of model interface configuration sets, and a test result corresponding to the new interface configuration is obtained by using the test data set to test a large model called based on the new interface configuration. The next new interface configuration in the search space is continued to search based on the plurality of model interface configuration sets, the evaluation results corresponding to the plurality of model interface configuration sets, the test result corresponding to the new interface configuration and the evaluation result corresponding to the new interface configuration, until a preset number of interface configurations are searched, and the target interface configuration is selected from the preset number of interface configurations based on evaluation results corresponding to the preset number of interface configurations.

Thus, the accuracy of recommending the model interface configuration can be improved by continuing to search for the new interface configuration in combination with the evaluation result corresponding to the searched model interface configuration.

For example, the preset number may be twice the number of candidate model interfaces in the search space, or may also be some other value, which may be determined according to the actual needs, which is not limited herein.

For example, it can be determined whether a certain law between the interface configuration and the evaluation result exists or not based on the evaluation results corresponding to the plurality of model interface configuration sets. In case that the law exists, a new interface configuration is searched in the search space based on the law, and in case the law is not found, a new interface configuration can be searched randomly from the search space.

For example, it may be determined, based on the evaluation results corresponding to the plurality of model interface configuration sets and a test result corresponding to the new interface configuration, whether the new interface configuration is more in line with the user needs compared with the plurality of model interface configuration sets. If the new interface configuration is more in line with the user needs, it may continue to search for a new interface configuration in the search space based on the method for searching for the new interface configuration. If the new interface configuration is not in line with the user needs, the method for searching may be adjusted, and the new interface configuration may be searched in the search space based on the adjusted method for searching.

For example, the plurality of model interface configuration sets and the new interface configuration may be searched by the target large language model, and then the target interface configuration may be determined from the searched interface configurations. The method for searching for the plurality of model interface configuration sets by using the target large language model can be seen as described in the above step 202, which will not be discussed herein.

For the step of searching for the new interface configuration in the search space based on the evaluation results corresponding to the plurality of model interface configuration sets, for example, a first output requirement for the model interface configuration may be obtained, and first prompt information is generated based on the plurality of model interface configuration sets, the evaluation results corresponding to the plurality of model interface configuration sets, the search space, and the first output requirement; and then the new interface configuration is obtained by inputting the first prompt information into a target large language model for processing.

The first output requirement for the model interface configuration may include one or more of: a goal of recommending the model interface configuration, a requirement for a number of model interface configurations, a first condition that the model interface configuration satisfies, and a format requirement for the model interface configuration, etc. For example, the goal of recommending the model interface configuration may be “outputting a model interface configuration that maximizes an evaluation score”, and the first condition may be “providing a model interface configuration that maximizes an evaluation score”. For example, the goal of recommending the model interface configuration may be “outputting a model interface configuration that minimizes an evaluation score”, and the first condition may be “providing a model interface configuration that minimizes an evaluation score”.

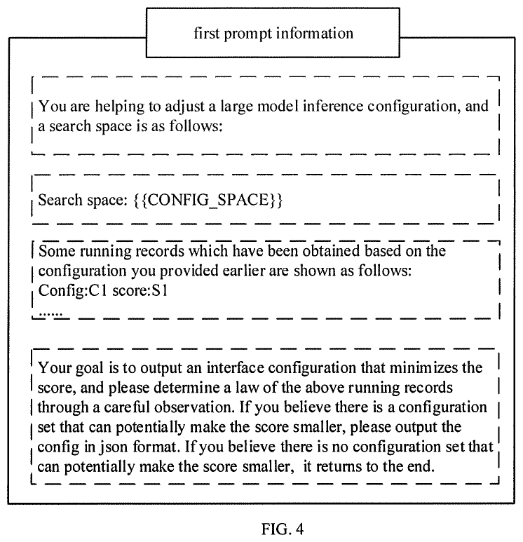

For example, the first prompt information may be as shown in FIG. 4, in which the goal of recommending the model interface configuration is to output the interface configuration that minimizes the score, and the format for the output model interface configuration is required to be a json format.

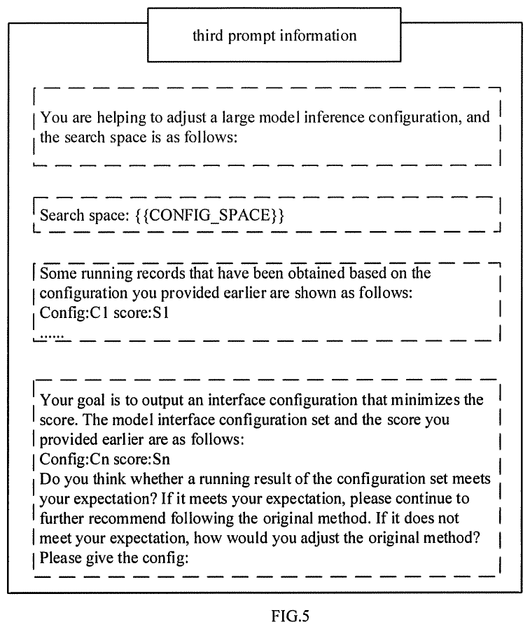

For example, the third prompt information may be generated based on the plurality of model interface configuration sets, the evaluation results corresponding to the plurality of model interface configuration sets, the test result corresponding to the new model interface configuration, the evaluation result corresponding to the new model interface configuration, the search space, the goal of recommending the model interface configuration, etc., and the new model interface configuration may be searched in the search space by inputting the third prompt information into the target large language model. For example, the third prompt information may be as shown in FIG. 5.

As a result, the accuracy and efficiency of recommending the model interface configuration can be improved by using the target large language model in combination with the previously searched interface configuration and the corresponding evaluation result to search for the new interface configuration.

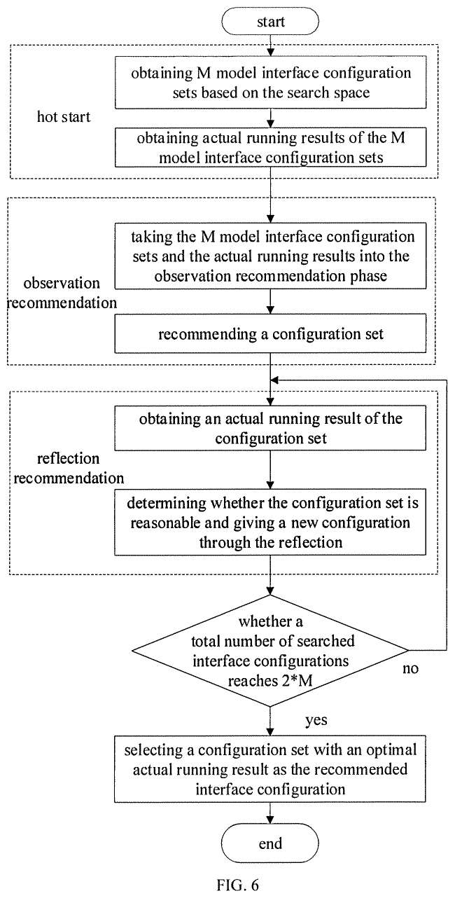

For example, a process of searching for the plurality of model interface configuration sets and the new interface configuration from the search space and determining the target interface recommended by using the target large language model can be divided into three parts, which are a hot start, an observation recommendation, and a reflection recommendation. For better understanding, the following is illustrated in conjunction with FIG. 6.

As shown in FIG. 6, the hot start serves as an initialization phase, which includes: obtaining M model interface configuration sets and actual running results of the M model interface configuration sets, in which the value of M is a number of candidate model interfaces. Then, the M model interface configuration sets and the actual running result are taken into the observation recommendation phase, and a new model interface configuration set is obtained through observation and recommendation based on the M model interface configuration sets and the actual running results. Then, the actual running result is obtained by executing the new model interface configuration set, and it is determined through the reflection recommendation, whether the previous model interface configuration set is reasonable and another new model interface configuration is given. Then, the observation and reflection are repeated until a total number of attempted model interface configurations reaches 2*M, and then a model interface configuration set with an optimal actual running result is selected as the target interface configuration. For example, the prompt information used in the hot start is shown in FIG. 3, the prompt information used in the observation recommendation is shown in FIG. 4, and the prompt information used in the reflection recommendation is shown in FIG. 5. The model interface configuration set with the optimal execution result may be a model interface configuration with the smallest score.

Due to the instability and heteroscedasticity of the interface recommended by the large language model, in order to facilitate observation and generalization of the target large language model from sparse data to search for a model interface configuration, for example, the evaluation result includes an evaluation score of the item to be evaluated, and a transformed evaluation score may be obtained by performing data transformation on the evaluation score corresponding to each model interface configuration set with a method for power transformation. Then, a new interface configuration may be searched in the search space by the target large language model based on the transformed evaluation scores corresponding to the plurality of model interface configuration sets.

For example, the new interface configuration may be searched in the search space by the target large language model based on the transformed evaluation scores corresponding to the plurality of model interface configuration sets, and the detailed process can be referred to the method for searching for the new model interface configuration based on the evaluation results corresponding to the plurality of model interface configuration sets by the target large language model in the above embodiments, which will not be discussed herein.

For example, the method for power transformation may include a Box-Cox transformation, a Yeo-Johnson transformation, etc.

Thus, the target large language model searches for the new model interface configuration based on the transformed evaluation score obtained by the method for power transformation, which can facilitate observation and generalization of the target large language model from the sparse data and improve the accuracy of recommending the model interface configuration.

It may be understood that the new interface configuration in the search space is continued to be searched based on the plurality of model interface configuration sets, the evaluation results corresponding to the plurality of model interface configuration sets, the test result corresponding to the new interface configuration and the evaluation result corresponding to the new interface configuration. Also, the power transformation may be performed on the evaluation scores corresponding to the plurality of model interface configuration sets and the evaluation score corresponding to the new model interface configuration, and then the new interface configuration is continued to be searched by the target large language model.

As another possible implementation, a goal of recommending the model interface configuration that matches the item to be evaluated may be determined; and the target interface configuration may be determined from the plurality of model interface configuration sets based on the goal of recommending the model interface configuration, and the evaluation results corresponding to the plurality of model interface configuration sets.

For example, the evaluation result includes an evaluation score, and the item to be evaluated is an average time latency of the interface call. The smaller the average time latency, the larger the evaluation score. Then the goal of recommending the model interface configuration is to select a model interface configuration with the largest evaluation score, and the model interface configuration with the largest evaluation score may be thus selected from the plurality of model interface configuration sets as the target interface configuration.

Thus, the recommended interface configuration is selected based on the goal of recommending the model interface configuration, which may enable the recommended interface configuration to be more in line with the user needs, and improve the accuracy of the recommendation.

In the embodiment of the present disclosure, the item to be evaluated in the test result corresponding to the interface configuration may be evaluated based on the first evaluation rule, and the target interface configuration may be determined based on the evaluation result corresponding to the interface configuration, which may improve the accuracy of the recommendation, and different evaluation rules may be used for evaluation according to different recommendation needs, thus satisfying the diversified needs.

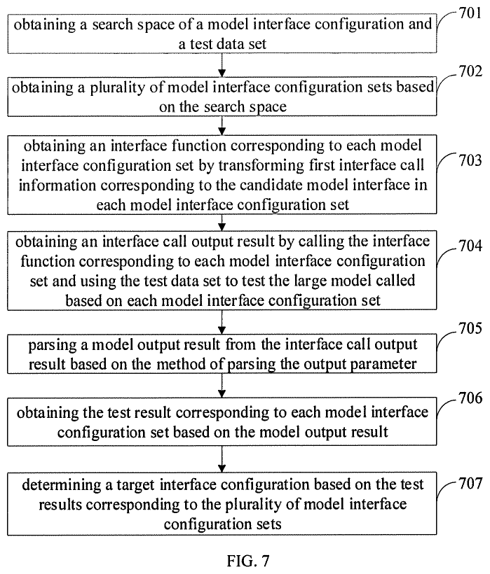

FIG. 7 is a flowchart illustrating a method for recommending a large model interface configuration according to another embodiment of the present disclosure.

As shown in FIG. 7, the method for recommending a large model interface configuration includes the following steps 701 to 707.

At step 701, a search space of a model interface configuration and a test data set are obtained.

In the present disclosure, the step 701 may be performed by any one implementation of the embodiments of the present disclosure, which will not be discussed herein.

At step 702, a plurality of model interface configuration sets are obtained based on the search space.

In the present disclosure, the step 702 may be performed by any one implementation of the embodiments of the present disclosure, which will not be discussed herein.

At step 703, an interface function corresponding to each model interface configuration set is obtained by transforming first interface call information corresponding to a candidate model interface in each model interface configuration set.

The first interface call information may include, but is not limited to, an interface identifier of the candidate model interface, a uniform resource locator (URL) path of the candidate model interface, a value of an input parameter, a method for parsing an output parameter, etc. For example, the interface identifier may be an interface name, or other forms of identifier, etc. For example, an interface name of the candidate model interface is ““ model1””.

For example, the input parameter value may be expressed as, a fixed constant, or a hyperparameter name in the corresponding interface configuration searched through the jsonpath.

For example, the method for parsing the output parameter may be parsing the required result from the output of the interface call. For example, the required result may be parsed from the output of the interface call through the jsonpath corresponding to the output parameter.

In the present disclosure, the first interface call information corresponding to the candidate model interface in each model interface configuration set may be transformed into an executable interface function.

At step 704, the interface function corresponding to each model interface configuration set is called and the test data set is used to test the large model corresponding to each model interface configuration set, so as to obtain an interface call output result.

The interface call output result may include a model output result obtained by inputting the test data from the test data set into the large model, and may also include response state information, a model version, a model update time etc. The response state information may include, for example, a call success, error information, etc., and the response state information may be configured to determine whether the call is successful.

For example, the interface call output result may be in a json format, or may also be in other formats, which is not limited herein.

At step 705, a model output result is parsed from the interface call output result based on the method of parsing the output parameter.

Since the interface call output result may contain many contents, in the present disclosure, the interface call output result may be parsed, and the model output result is extracted from the interface call output result according to the method of parsing the output parameter.

For example, the interface call output result is represented in a json format, and the method of parsing the output parameter includes jsonpath corresponding to the output parameter, and the model output result may be parsed from the interface call output result through the jsonpath.

At step 706, the test result corresponding to each model interface configuration set is obtained based on the model output result.

In this disclosure, the model output result corresponding to the model interface configuration may be determined as the test result corresponding to the model interface configuration.

Alternatively, a call unit price of the large model labeled by the large model platform may be obtained to calculate a call cost, an average call time latency of the interface configuration may be also obtained, and the test result corresponding to the model interface configuration may be obtained based on the model output result, the call cost, the average call time latency etc. That is, the test result corresponding to the model interface configuration may include the model output result, the call cost, the average call time latency etc.

At step 707, a target interface configuration is determined based on the test results corresponding to the plurality of model interface configuration sets.

In the present disclosure, the step 707 may be performed by any one implementation of the embodiments of the present disclosure, which will not be discussed herein.

In the embodiment of the present disclosure, the interface function corresponding to each model interface configuration set is obtained by transforming the first interface call information corresponding to the candidate model interface in each model interface configuration set, the interface call output result is obtained by calling the interface function corresponding to each model interface configuration set and using the test data set to test the large model corresponding to each model interface configuration set, and the model output result is accurately parsed from the interface call output result based on the method of parsing the output parameter in the first interface call information, which improves the efficiency of testing, and thus improves the efficiency of recommending the model interface configuration.

In an embodiment of the present disclosure, registration of the interface call information may be performed, and the interface call information that is successfully registered may be available for users.

For example, the user may input second interface call information to be registered on the client interface and trigger a registration control, and the client, in response to detecting that the registration control of the interface call information has been triggered, sends a request of registering the interface call information to the server. Then, the server may receive the request of registering the interface call information. The request of registering the interface call information may include the second interface call information, and the second interface call information may include the interface identifier, and may also include the URL path, the value of the input parameter, the method of parsing the output parameter, etc.

The server may verify the second interface call information, such as verifying whether the input parameters are reasonable, etc. In case that the verifying of the second interface call information passes, it may be determined whether the interface identifier in the second interface call information exists in a first database. In case that the interface identifier does not exist in the first database, which means that the second interface call information has not been registered, then the second interface call information may be stored into the first database. In case that the interface identifier exists in the first database, which means that the second interface call information has been registered, then the interface call information corresponding to the interface identifier in the first database may be updated by using the second interface call information.

In case that the verifying of the second interface call information does not pass, prompting information of a registration failure may be generated, which may include a reason for the registration failure.

It is to be noted that, in the present disclosure, the second interface call information may be the same as or different from the first interface call information as described above, which is not limited herein.

In the embodiment of the present disclosure, the second interface call information to be registered is verified, when the verifying step passes, it is determined whether the second interface call information has been stored in the first database, and the second interface call information may be registered or updated according to the determination result, which improves the efficiency and success rate of the registration.

Further, registration state information of the second interface call information may be generated based on a registration result of the second interface call information, in which the registration state information includes any one of: a registration success, a registration failure, an update success, or an update failure.

For example, in case that the second interface call information is successfully stored in the first database, which indicates that the registration is successful, then the registration state information is the registration success. In case that the second interface call information is not successfully stored in the first database, then the registration state information is the registration failure.

For example, in case that the interface call information corresponding to the interface identifier is successfully updated by using the second interface call information, then the registration state information is the update success. In case that the interface call information corresponding to the interface identifier is not successfully updated by using the second interface call information, then the registration state information is the update failure.

For example, the registration state information of the second interface registration call information may be returned to the client for display. Further, in case that the second interface call information is successfully registered or successfully updated, the interface identifier in the second interface call information may also be returned.

Thus, the user may be easily informed of the registration state of the interface call information by generating the registration state information of the interface call information.

In an embodiment of the present disclosure, registration of the evaluation information may be performed, and the evaluation information that is successfully registered may be available for users.

For example, the user may input second evaluation information to be registered on the client interface and trigger the registration control, and the client, in response to detecting that the registration control of the evaluation information has been triggered, sends a request of registering the evaluation information to the server. Then, the server may receive the request of registering the evaluation information.

The request of registering the evaluation information may include the second evaluation information, and the second evaluation information may include a second evaluation identifier, a second evaluation rule, etc. The second evaluation identifier may be configured to identify the second evaluation information, and the second evaluation identifier may be a name of the second evaluation information. For example, the name of the second evaluation information is “evaluator1”.

The server obtains the second evaluation information from the request of registering the evaluation information and determines whether the second evaluation identifier is contained in the second database. In case that the second evaluation identifier does not exist in the second database, which means that the second evaluation information has not been registered, then the second evaluation information is stored into the second database. In case that the second evaluation identifier exists in the second database, which means that the second evaluation information has been registered, an evaluation rule corresponding to the second evaluation identifier in the second database may be updated by using the second evaluation rule.

In the embodiment of the present disclosure, the second evaluation information is registered or updated according to a result of whether the second evaluation identifier of the second evaluation information exists in the second database, which improves the efficiency and success rate of the registration.

Further, registration state information of the second evaluation information is generated based on a registration result of the second evaluation information, in which the registration state information includes any one of: a registration success, a registration failure, an update success, or an update failure.

For example, in case that the second evaluation information is successfully stored in the second database, which means that the registration is successful, then the registration state information is the registration success. In case that the second evaluation information is not successfully stored in the second database, then the registration state information is the registration failure.

For example, in case that the evaluation information corresponding to the second evaluation identifier is successfully updated by using the second evaluation information, then the registration state information is the update success. In case that the evaluation information corresponding to the second evaluation identifier is not successfully updated by using the second evaluation information, then the registration state information is the update failure.

For example, the registration state information of the second evaluation information may be returned to the client for display. Further, in case that the second evaluation information is successfully registered or successfully updated, the second evaluation identifier in the second evaluation information may also be returned.

Thus, the user can be easily informed of the registration state of the evaluation information by generating the registration state information of the evaluation information.

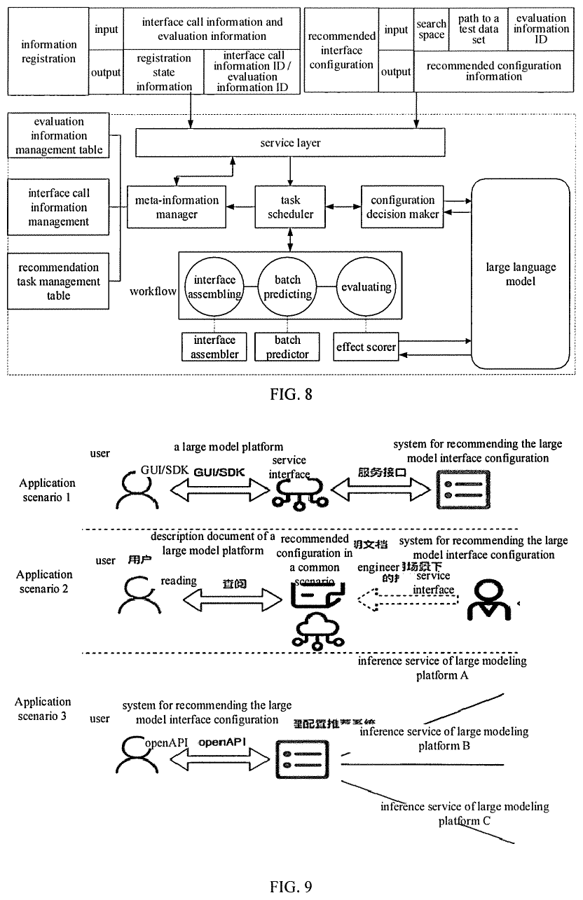

For better understanding, the method for recommending a large model interface configuration according to the embodiments of the present disclosure is illustrated below in conjunction with FIG. 8. FIG. 8 is a block diagram illustrating a system for recommending a large model interface configuration according to an embodiment of the present disclosure.

As shown in FIG. 8, the system for recommending may internally include components such as a service layer, a task scheduler, a meta-information manager, a configuration decision maker, an interface assembler, a batch predictor, an effect scorer, etc.

The service layer is configured to provide an external interface, including information registration, recommendation task submission, and status query, etc.

The task scheduler is configured to coordinate various components internally to complete the configuration recommendation task, initiate a request to the configuration decision maker to obtain the interface configuration, send other parameters such as the interface configuration in a workflow manner for execution, obtain the execution result of the workflow and interact the execution result with the configuration decision maker.

The meta-information manager is configured to perform addition, deletion, modification and checking operations on the persistent database, including three data tables, i.e., an evaluation information management table, an interface call information management table, and a recommendation task management table.

The configuration decision maker is implemented by a large language model with parameter scale over 60 B, which is written as Ms. Since the large language model has rich knowledge and a strong ability of sparse data generalization, such model has advantages of a good initialization configuration and a high efficiency of iteratively recommending a configuration compared with conventional methods such as random sampling, Bayesian optimization. The execution process of the configuration decision maker is in three parts: hot start, observation recommendation, and reflection recommendation, as detailed in FIG. 6, in which the B in 60 B refers to Billion.

First, the hot start serves as the initialization phase, and the configuration decision maker will first provide M model interface configuration sets, in which the value of M is the number of candidate model interfaces. In addition, a new model interface configuration set is obtained by observing and recommending and each of the new model interface configuration set is executed to obtain actual running results. Then, a new interface configuration is obtained by data observation and reflection of the actual running results. The observation and reflection are subsequently repeated by placing the last round of recommended interface configuration and its running result into the observation part, executing and reflecting the latest round of interface configuration to get the new interface configuration, until the total number of attempted model interface configurations reaches 2*M.

For example, prompt words used in the hot start (i.e., prompt information) is shown in FIG. 3, prompt words used in the observation recommendation is shown in FIG. 4, and prompt words used in the reflection recommendation is shown in FIG. 5.

Due to the instability and heteroskedasticity of the inference result of the large model, in order to facilitate observation and generalization of the model Ms from the sparse data, the actual evaluation score of the configuration can be calibrated and output by using Box-Cox and Yeo-Jonhson, before observing by the model Ms.

The interface assembler is configured to transform the registered interface call information into an executable interface function.

The batch predictor is configured to obtain the actual test data set according to a path to the test data and call the interface function.

The effect scorer is implemented by a large language model with a parameter scale over 60 B, which needs to provide a scoring prompt template such as an evaluation rule to get a score for an inference state of each problem. The inference state may include a model output result. Operational meta-information such as an inference time latency, and a cost may also be combined.

As shown in FIG. 8, the input of the system for recommending may include a search space for the model interface configuration, a path to a test data set, an evaluation information ID, etc., and the output of the system may be a configuration information recommended, in which the configuration information recommended may include an interface configuration recommended, running information of the interface configuration recommended such as an average call time latency, a call cost, etc. For example, the configuration information recommended may be fed back to the user in the form of a report table, including all attempted interface configurations and the running information thereof. The recommended interface configuration is labeled in the report table. The running information may include the average call time latency, the call cost, etc.

The operations of the recommendation system include two parts: an information registration and a configuration recommendation task. The information registration includes the registration of both interface call information and evaluation information, which is a prerequisite for the operation of the configuration recommendation task. In a case where the interface call information or the evaluation information to be selected by the user is not stored in the system, a registration operation is required first to obtain the corresponding interface call information and evaluation information. A list of available interface call information and a list of available evaluation information may also be obtained by calling the service interface directly.

The process of information registration is as follows:
(1) call a registration interface for a service is called and the model interface call information or the evaluation information is input to the system;
(2) the service layer verifies the interface call information or the evaluation information;
(3) in a case where the verifying passes, the service layer stores the interface call information or the evaluation information in the meta-information manager, and in a case where the interface call information or the evaluation information already exists in the manager, an update success is returned; in a case where the interface call information or the evaluation information does not exist in the manager, a registration success is returned.

For example, during the information registration, the input parameter is the interface call information or the evaluation information, and the output parameter may include the registration state information, such as a registration success, an update success, a registration failure, or an update failure, which may be expressed as a string. In the case where the interface call information is registered or updated successfully, an interface call information ID at the time of registration may also be returned, and in the case where the evaluation information is registered or updated successfully, an evaluation information ID at the time of registration may also be returned.

For example, the evaluation information is verified, such as verifying the integrity of the evaluation information, etc.

The process of the configuration recommendation task is as follows:
(1) the system service layer receives the input parameters such as the search space for the model interface configuration, the path to the test data set, and the evaluation information, etc., and after passing the verification, basic information of the task T is input into the meta-information manager for management, and the task T is recorded as one recommendation task T;
(2) the task scheduling layer sends the search space to the configuration decision maker;
(3) the configuration decision maker returns some configurations to the task scheduling layer. After the task scheduling layer calls the meta-information manager to manage the configurations, the task scheduling layer assembles large model service call interfaces based on the configurations, initiates batch prediction tasks on the test data set one by one, which is noted as a batch prediction task t, and a concurrency control of batch prediction tasks may be implemented by an execution pool;
(4) in a case where the batch prediction task t is completed, the task scheduling layer collects the average time latency of the interface call and the cost of the interface call for each interface configuration set, then the task scheduler calls the effect scorer to score the batch prediction results;
(5) the task scheduling layer collects an average score of each model interface configuration set from the effect scorer and sends the average score to the meta-information manager for management. The task scheduling layer feeds back the average score to the configuration decision maker, which may determine independently whether to provide a new interface configuration or to stop searching the interface configuration. In a case where a new interface configuration is provided, the steps (3) to (5) in the process are repeated until no new interface configuration is generated;
(6) the service layer takes out the interface configuration recommended and other meta-information outputs from the meta-information manager.

The basic information of task T which passes the verifying as described above is input into the meta-information manager for management. Verifying the input parameter means verifying whether the search space and the path to the test data set are reasonable, and whether the evaluation information is registered, etc. The basic information of task T refers to these input parameters.

The other meta-information outputted by the service layer as described above may include the average call time latency of the interface configuration recommended, the call cost of the interface configuration recommended, etc.

The method for recommending a large model interface configuration in the present disclosure, may be applied in a variety of scenarios, for example, as shown in FIG. 9.

Application scenario 1: for a certain large model development platform or a certain large model application platform, a large model interface and evaluation information owned by itself may be registered into the system for recommending the large model interface configuration, then the service layer of the platform is encapsulated, and a visual interface or SDK is provided for the user. In this way, the platform helps the user to predict and select the call interface.

Application scenario 2: for a certain large model development platform or a certain large model application platform, common fields and recommended parameters that each model is good at are obtained in advance by the recommending system, and information of the common fields and the recommended parameters that each model is good at are provided in a help/description document called by a prediction service.

Application scenario 3: the recommending system is served as a third party tool, to search and recommend a large model interface configuration across the plurality of platforms.

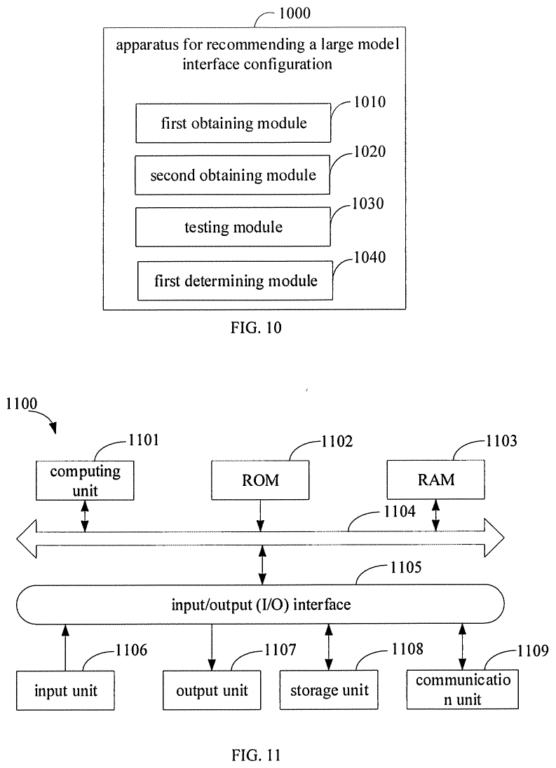

To realize the above embodiments, the embodiments of the disclosure also provide an apparatus for a large model interface configuration recommendation. FIG. 10 is a structure diagram illustrating an apparatus for recommending a large model interface configuration according to an embodiment of the present disclosure.

As shown in FIG. 10, the apparatus 1000 for a large model interface configuration recommendation includes a first obtaining module 1010, a second obtaining module 1020, a testing module 1030 and a first determining module 1040.

The first obtaining module 1010 is configured to obtain a search space of a model interface configuration and a test data set, in which the search space includes at least one candidate model interface and a value range of a hyperparameter.

The second obtaining module 1020 is configured to obtain a plurality of model interface configuration sets based on the search space, in which each model interface configuration set includes a candidate model interface and a value of the hyperparameter.

The testing module 1030 is configured to obtain a test result corresponding to each model interface configuration set, by using the test data set to test a large model called based on each model interface configuration set.

The first determining module 1040 is configured to determine a target interface configuration based on the test results corresponding to the plurality of model interface configuration sets.

Alternatively, the first determining module 1040 is configured to: obtain a first evaluation identifier and obtain a first evaluation rule based on the first evaluation identifier, in which the first evaluation rule includes an item to be evaluated; and obtain an evaluation result corresponding to each model interface configuration set, by evaluating the item to be evaluated in the test result corresponding to each model interface configuration set based on the first evaluation rule; and determine the target interface configuration based on the evaluation results corresponding to the plurality of model interface configuration sets.

Alternatively, the first determining module 1040 is configured to: search for a new interface configuration in the search space based on the evaluation results corresponding to the plurality of model interface configuration sets; and obtain a test result corresponding to the new interface configuration by using the test data set; and obtain an evaluation result corresponding to the new interface configuration, by evaluating the item to be evaluated in the test result corresponding to the new interface configuration based on the first evaluation rule; and continue to search for the new interface configuration in the search space based on the plurality of model interface configuration sets, the evaluation results corresponding to the plurality of model interface configuration sets, the test result corresponding to the new interface configuration and the evaluation result corresponding to the new interface configuration, until a preset number of interface configurations are searched, and select the target interface configuration from the preset number of interface configurations based on evaluation results corresponding to the preset number of interface configurations.

Alternatively, the first determining module 1040 is configured to: obtain a first output requirement for the model interface configuration, in which the first output requirement for the model interface configuration includes at least one of: a goal of recommending the model interface configuration, a requirement for a number of model interface configurations, a first condition that the model interface configuration satisfies, and a format requirement for the model interface configuration; and generate first prompt information based on the plurality of model interface configuration sets, the evaluation results corresponding to the plurality of model interface configuration sets, the search space, and the first output requirement; and obtain the new interface configuration by inputting the first prompt information into a target large language model for processing.

Alternatively, the evaluation result includes an evaluation score for the item to be evaluated, and the first determining module 1040 is configured to: obtain a transformed evaluation score by performing data transformation on the evaluation score corresponding to each model interface configuration set with a method for power transformation; and search for the new interface configuration in the search space by using the target large language model based on the transformed evaluation scores corresponding to the plurality of model interface configuration sets.

Alternatively, the first determining module 1040 is configured to: determine a goal of recommending the model interface configuration that matches the item to be evaluated; and determine the target interface configuration from the plurality of model interface configuration sets based on the goal of recommending the model interface configuration, and the evaluation results corresponding to the plurality of model interface configuration sets.

Alternatively, the second obtaining module 1020 is configured to: obtain a second output requirement for the model interface configuration, in which the second output requirement for the model interface configuration includes at least one of: a second condition that the model interface configuration satisfies, a requirement for a number of model interface configurations, and a format requirement for the model interface configuration; and generate second prompt information based on the search space and the second output requirement; and obtain the plurality of model interface configuration sets by inputting the second prompt information into the target large language model for processing.

Alternatively, the testing module 1030 is configured to: obtain an interface function corresponding to each model interface configuration set by transforming first interface call information corresponding to the candidate model interface in each model interface configuration set, in which the first interface call information includes a value of an input parameter, and a method of parsing an output parameter; and obtain an interface call output result by calling the interface function corresponding to each model interface configuration set and using the test data set to test the large model corresponding to each model interface configuration set; and parse a model output result from the interface call output result based on the method of parsing the output parameter; and obtain the test result corresponding to each model interface configuration set based on the model output result.

Alternatively, the apparatus may further includes a third obtaining module, a second determining module, a first storing module and a first update module.

The third obtaining module is configured to obtain second interface call information to be registered, and verify the second interface call information, in which the second interface call information includes an interface identifier.

The second determining module is configured to determine whether the interface identifier exists in a first database in case that the verifying of the second interface call information passes.

The first storing module is configured to store the second interface call information into the first database in case that the interface identifier does not exist in the first database.

The first update module is configured to update interface call information corresponding to the interface identifier in the first database by using the second interface call information in case that the interface identifier exists in the first database.

Alternatively, the apparatus may further includes a generating module. The generating module is configured to generate registration state information of the second interface call information based on a registration result of the second interface call information, in which the registration state information includes any one of: a registration success, an update success, a registration failure, or an update failure.

Alternatively, the apparatus may further includes a fourth obtaining module, a second storing module and a second updating module.

The fourth obtaining module is configured to obtain second evaluation information to be registered, in which the second evaluation information includes a second evaluation identifier and a second evaluation rule.

The second storing module is configured to store the second evaluation information into the second database in case that the second evaluation identifier does not exist in the second database.

The second updating module is configured to update an evaluation rule corresponding to the second evaluation identifier in the second database by using the second evaluation rule in case that the second evaluation identifier exists in the second database.

It should be noted that the foregoing explanatory description of the embodiments of the method for recommending a large model interface configuration is also applicable to the embodiments of the apparatus for recommending a large model interface configuration, which is not repeated herein.

In the embodiment of the present disclosure, the plurality of model interface configuration sets are obtained based on the search space, and the test result corresponding to each model interface configuration set is obtained by using the test data set to test the large model called based on each model interface configuration set, and the target interface configuration is determined based on the test results corresponding to the plurality of model interface configuration sets. Thus, the accuracy and efficiency of recommending the large model interface configuration may be improved by using the test data set to search for the interface configuration recommended from the search space.

According to embodiments of the present disclosure, it also provides an electronic device, a readable storage medium, and a computer program product.

Referring to FIG. 11, it is a block diagram illustrating an electronic device 1100 according to an embodiment of the present disclosure. The electronic device is intended to represent various types of digital computers, such as laptop computers, desktop computers, workstations, personal digital assistants, servers, blade servers, mainframe computers, and other suitable computers. The electronic device may also represent various types of mobile devices, such as personal digital assistants, cellular phones, smart phones, wearable devices, and other similar computing devices. The components shown herein, their connections and relations, and their functions are merely examples, which are not intended to limit the implementations of the disclosure described and/or required herein.

As shown in FIG. 11, the device 1100 includes a computing unit 1101, configured to execute various appropriate actions and processes according to a computer program stored in a read-only memory (ROM) 1102 or a computer program loaded from a storage unit 1108 to a random access memory (RAM) 1103. In the RAM 1103, various programs and data required for the device 1100 may be stored. The computing unit 1101, the ROM 1102 and the RAM 1103 may be connected with each other by a bus 1104. An input/output (I/O) interface 1105 is also connected to the bus 1104.

The plurality of components in the device 1100 are connected to the I/O interface 1105, which include: an input unit 1106, for example, a keyboard, a mouse; an output unit 1107, for example, various types of displays, speakers; a storage unit 1108, for example, a magnetic disk, an optical disk; and a communication unit 1109, for example, a network card, a modem, a wireless transceiver. The communication unit 1109 allows the device 1100 to exchange information/data through a computer network such as Internet and/or various types of telecommunication networks with other devices.

The computing unit 1101 may be various types of general and/or dedicated processing components with processing and computing abilities. Some examples of a computing unit 1101 include but not limited to a central processing unit (CPU), a graphic processing unit (GPU), various dedicated artificial intelligence (AI) computing chips, various computing units on which a machine learning model algorithm is running, a digital signal processor (DSP), and any appropriate processor, controller, microcontroller, etc. The computing unit 1101 executes various methods and processes as described above, for example, a method for recommending a large model interface configuration. For example, in some embodiments, the method for recommending a large model interface configuration may be further implemented as a computer software program, which is tangibly contained in a machine readable medium, such as the storage unit 1108. In some embodiments, a part or all of the computer program may be loaded and/or installed on the device 1100 via the ROM 1102 and/or the communication unit 1109. When the computer program is loaded on the RAM 1103 and executed by the computing unit 1101, one or more steps in the method for recommending a large model interface configuration be performed as described above. Optionally, in other embodiments, the computing unit 1101 may be configured to the method for recommending a large model interface configuration in other appropriate ways (for example, by virtue of a firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAMS, ROMs, Electrically Programmable Read-Only-Memory (EPROM), fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: a Local Area Network (LAN), a Wide Area Network (WAN), the Internet and a block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system to solve management difficulty and weak business scalability defects that exist in a conventional physical host and a Virtual Private Server. The server may also be a server of a distributed system, or a server combined with a block-chain.

According to an embodiment of the present disclosure, a computer program product is also provided, which includes instructions which when executed by a processor to perform the method for recommending a large model interface configuration according to the embodiments of the present disclosure as described above.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the principle of the disclosure shall be included in the protection scope of the disclosure.

1. A computer-implemented method for recommending a large model interface configuration, the method comprising:
obtaining a search space of a model interface configuration and a test data set, wherein the search space comprises at least one candidate model interface and a value range of a hyperparameter; and
obtaining a plurality of model interface configuration sets based on the search space, wherein each model interface configuration set comprises a candidate model interface and a value of the hyperparameter; and
obtaining a test result corresponding to each model interface configuration set, by using the test data set to test a large model called based on each model interface configuration set; and
determining a target interface configuration based on the test results corresponding to the plurality of model interface configuration sets.

2. The method according to claim 1, wherein determining the target interface configuration based on the test results corresponding to the plurality of model interface configuration sets comprises:
obtaining a first evaluation identifier and obtaining a first evaluation rule based on the first evaluation identifier, wherein the first evaluation rule comprises an item to be evaluated; and
obtaining an evaluation result corresponding to each model interface configuration set, by evaluating the item to be evaluated in the test result corresponding to each model interface configuration set based on the first evaluation rule; and
determining the target interface configuration based on the evaluation results corresponding to the plurality of model interface configuration sets.

3. The method according to claim 2, wherein determining the target interface configuration based on the evaluation results corresponding to the plurality of model interface configuration sets comprises:
searching for a new interface configuration in the search space based on the evaluation results corresponding to the plurality of model interface configuration sets;
obtaining a test result corresponding to the new interface configuration by using the test data set;
obtaining an evaluation result corresponding to the new interface configuration, by evaluating the item to be evaluated in the test result corresponding to the new interface configuration based on the first evaluation rule; and
continuing to search for another new interface configuration in the search space based on the plurality of model interface configuration sets, the evaluation results corresponding to the plurality of model interface configuration sets, the test result corresponding to the new interface configuration and the evaluation result corresponding to the new interface configuration, until a preset number of interface configurations are searched, and selecting the target interface configuration from the preset number of interface configurations based on evaluation results corresponding to the preset number of interface configurations.

4. The method according to claim 3, wherein searching for the new interface configuration in the search space based on the evaluation results corresponding to the plurality of model interface configuration sets comprises:
obtaining a first output requirement for the model interface configuration, wherein the first output requirement comprises at least one of: a goal of recommending the model interface configuration, a requirement for a number of model interface configurations, a first condition that the model interface configuration satisfies, and a format requirement for the model interface configuration;
generating first prompt information based on the plurality of model interface configuration sets, the evaluation results corresponding to the plurality of model interface configuration sets, the search space, and the first output requirement; and
obtaining the new interface configuration by inputting the first prompt information into the large model for processing.

5. The method according to claim 3, wherein the evaluation result comprises an evaluation score for the item to be evaluated, and searching for the new interface configuration in the search space based on the evaluation results corresponding to the plurality of model interface configuration sets comprises:
obtaining a transformed evaluation score by performing data transformation on the evaluation score corresponding to each model interface configuration set with a method for power transformation; and
searching for the new interface configuration in the search space by using the large model based on the transformed evaluation scores corresponding to the plurality of model interface configuration sets.

6. The method according to claim 2, wherein determining the target interface configuration based on the evaluation results corresponding to the plurality of model interface configuration sets comprises:
determining a goal of recommending the model interface configuration that matches the item to be evaluated; and
determining the target interface configuration from the plurality of model interface configuration sets based on the goal of recommending the model interface configuration, and the evaluation results corresponding to the plurality of model interface configuration sets.

7. The method according to claim 1, wherein obtaining the plurality of model interface configuration sets based on the search space comprises:
obtaining a second output requirement for the model interface configuration, wherein the second output requirement for the model interface configuration comprises at least one of: a second condition that the model interface configuration satisfies, a requirement for a number of model interface configurations, and a format requirement for the model interface configuration; and
generating second prompt information based on the search space and the second output requirement; and
obtaining the plurality of model interface configuration sets by inputting the second prompt information into the large model for processing.

8. The method according to claim 1, wherein obtaining the test result corresponding to each model interface configuration set, by using the test data set to test the large model called based on each model interface configuration set comprises:
obtaining an interface function corresponding to each model interface configuration set by transforming first interface call information corresponding to the candidate model interface in each model interface configuration set, wherein the first interface call information comprises a value of an input parameter, and a method of parsing an output parameter; and
obtaining an interface call output result by calling the interface function corresponding to each model interface configuration set and using the test data set to test the large model called based on each model interface configuration set; and
parsing a model output result from the interface call output result based on the method of parsing the output parameter; and
obtaining the test result corresponding to each model interface configuration set based on the model output result.

9. The method according to claim 1, further comprising:
obtaining second interface call information to be registered, and verifying the second interface call information, wherein the second interface call information comprises an interface identifier; and
determining whether the interface identifier exists in a first database in case that the verifying of the second interface call information passes; and
storing the second interface call information into the first database in case that the interface identifier does not exist in the first database; and
updating interface call information corresponding to the interface identifier in the first database by using the second interface call information in case that the interface identifier exists in the first database.

10. The method according to claim 9, further comprising:
generating registration state information of the second interface call information based on a registration result of the second interface call information, wherein the registration state information comprises any one of: a registration success, an update success, a registration failure, or an update failure.

11. The method according to claim 1, further comprising:
obtaining second evaluation information to be registered, wherein the second evaluation information comprises a second evaluation identifier and a second evaluation rule; and
storing the second evaluation information into a second database in case that the second evaluation identifier does not exist in the second database; and
updating an evaluation rule corresponding to the second evaluation identifier in the second database by using the second evaluation rule in case that the second evaluation identifier exists in the second database.

12. An electronic device, comprising:
at least one processor; and
a memory communicatively coupled to the at least one processor and storing instructions executable by the at least one processor;
wherein the at least one processor is configured to:
obtain a search space of a model interface configuration and a test data set, wherein the search space comprises at least one candidate model interface and a range of a hyperparameter; and
obtain a plurality of model interface configuration sets based on the search space, wherein each model interface configuration set comprises a candidate model interface and a value of the hyperparameter; and
obtain a test result corresponding to each model interface configuration set, by using the test data set to test a large model called based on each model interface configuration set; and
determine a target interface configuration based on the test results corresponding to the plurality of model interface configuration sets.

13. The electronic device according to claim 12, wherein the at least one processor is further configured to:
obtain a first evaluation identifier and obtain a first evaluation rule based on the first evaluation identifier, wherein the first evaluation rule comprises an item to be evaluated; and
obtain an evaluation result corresponding to each model interface configuration set, by evaluating the item to be evaluated in the test result corresponding to each model interface configuration set based on the first evaluation rule; and
determine the target interface configuration based on the evaluation results corresponding to the plurality of model interface configuration sets.

14. The electronic device according to claim 13, wherein the at least one processor is further configured to:
search for a new interface configuration in the search space based on the evaluation results corresponding to the plurality of model interface configuration sets;
obtain a test result corresponding to the new interface configuration by using the test data set;
obtain an evaluation result corresponding to the new interface configuration, by evaluating the item to be evaluated in the test result corresponding to the new interface configuration based on the first evaluation rule; and
continue to search for another new interface configuration in the search space based on the plurality of model interface configuration sets, the evaluation results corresponding to the plurality of model interface configuration sets, the test result corresponding to the new interface configuration and the evaluation result corresponding to the new interface configuration, until a preset number of interface configurations are searched, and select the target interface configuration from the preset number of interface configurations based on evaluation results corresponding to the preset number of interface configurations.

15. The electronic device according to claim 14, wherein the at least one processor is further configured to:
obtain a first output requirement for the model interface configuration, wherein the first output requirement comprises at least one of: a goal of recommending the model interface configuration, a requirement for a number of model interface configurations, a first condition that the model interface configuration satisfies, and a format requirement for the model interface configuration;
generate first prompt information based on the plurality of model interface configuration sets, the evaluation results corresponding to the plurality of model interface configuration sets, the search space, and the first output requirement; and
obtain the new interface configuration by inputting the first prompt information into the large model for processing.

16. The electronic device according to claim 14, wherein the evaluation result comprises an evaluation score for the item to be evaluated, and the at least one processor is further configured to:
obtain a transformed evaluation score by performing data transformation on the evaluation score corresponding to each model interface configuration set with a method for power transformation; and
search for the new interface configuration in the search space by using the target large language model based on the transformed evaluation scores corresponding to the plurality of model interface configuration sets.

17. The electronic device according to claim 13, wherein the at least one processor is further configured to:
determine a goal of recommending the model interface configuration that matches the item to be evaluated; and
determine the target interface configuration from the plurality of model interface configuration sets based on the goal of recommending the model interface configuration, and the evaluation results corresponding to the plurality of model interface configuration sets.

18. The electronic device according to claim 12, wherein the at least one processor is further configured to:
obtain a second output requirement for the model interface configuration, wherein the second output requirement for the model interface configuration comprises at least one of: a second condition that the model interface configuration satisfies, a requirement for a number of model interface configurations, and a format requirement for the model interface configuration; and
generate second prompt information based on the search space and the second output requirement; and
obtain the plurality of model interface configuration sets by inputting the second prompt information into the large model for processing.

19. The electronic device according to claim 12, wherein the at least one processor is further configured to:
obtain an interface function corresponding to each model interface configuration set by transforming first interface call information corresponding to the candidate model interface in each model interface configuration set, wherein the first interface call information comprises a value of an input parameter, and a method of parsing an output parameter; and
obtain an interface call output result by calling the interface function corresponding to each model interface configuration set and use the test data set to test the large model called based on each model interface configuration set; and
parse a model output result from the interface call output result based on the method of parsing the output parameter; and
obtain the test result corresponding to each model interface configuration set based on the model output result.

20-23. (canceled)

24. A non-transitory computer readable storage medium, storing computer instructions, wherein the computer instructions are caused to enable a computer to perform a method for recommending a large model interface configuration, the method comprising:
obtaining a search space of a model interface configuration and a test data set. wherein the search space comprises at least one candidate model interface and a value range of a hyperparameter; and
obtaining a plurality of model interface configuration sets based on the search space, wherein each model interface configuration set comprises a candidate model interface and a value of the hyperparameter; and
obtaining a test result corresponding to each model interface configuration set, by using the test data set to test a large model called based on each model interface configuration set; and
determining a target interface configuration based on the test results corresponding to the plurality of model interface configuration sets.

25. (canceled)
